(19) United States
(12) Patent Application Publication
(10) Pub. No.: US 2009/0128271 A1
(43) Pub. Date: May 21, 2009

(54) SOLENOID

(75) Inventor: Nobuhide Okada, Osato-gun (JP)

Correspondence Address: OCCHIUTI ROHLICEK & TSAO, LLP, 10 FAWCETT STREET, CAMBRIDGE, MA, 02138, US

(73) Assignee: Shindengen Mechatronics co., Ltd

(21) Appl. No.: 12/297,528

(22) PCT Filed: Apr. 18, 2007
(86) PCT No.: PCT/JP2007/058431

§ 371 Date: Oct. 17, 2008

(30) Foreign Application Priority Data
Apr. 18, 2006 (JP) 2006 114965

(51) Int. Cl. H01F 7/16

(52) U.S. Cl. 335/263

(57) ABSTRACT

A solenoid is provided with a reduced overall length, while providing the same force characteristics as the force characteristics of conventional solenoids or higher. The solenoid includes a fixed portion and a movable portion. Furthermore, the end of the movable portion includes a magnetic pole portion having at least two tapered faces. Moreover, the end of the fixed portion includes a magnetic pole portion having at least two tapered faces opposing the magnetic pole portion of the movable portion. Such a solenoid provides the force characteristics of the flat-type solenoid in a region where the gap is small, while maintaining the force characteristics of the cone-type solenoid in a region where the gap is large.

### TECHNICAL FIELD

The present invention relates to a configuration of a solenoid.

### BACKGROUND ART

In general, a solenoid converts electric energy into mechanical linear motion, thereby driving an outer mechanism (mechanical load) connected to a movable portion of the solenoid. Typical conventional examples include a flat-type solenoid as shown in FIG. 13, and a cone-type solenoid as shown in FIG. 14. As described later, there is a difference in the shape of the end portion between the flat-type solenoid shown in FIG. 13 and the cone-type solenoid shown in FIG. 14.

Each of these solenoids has a principal unit having a configuration including a coil 1, a shaft 2, a plunger (movable portion) 3, a casing 5, a bearing 6, an air-gap spacer 7, a bobbin 8, and a base (fixed portion) 9, as shown in FIG. 13 and FIG. 14.

Here, the coil 1 and the casing 5 form a main magnetic circuit 10. The main magnetic circuit 10 generates a magnetic field so as to drive the plunger (movable portion) 3. The plunger 3 serves as a movable magnetic pole portion, which is driven in the attracting direction shown in the drawing by the magnetic field generated by the main magnetic circuit 10. The air-gap spacer 7 provides a function of absorbing noise and a function of preventing residual magnetism when the plunger 3 comes into contact with the casing 5. The bobbin 8 is an insulating member provided between the coil 1 and the casing 5. The base 9 serves as a fixed magnetic pole portion.

In general, the solenoid has a configuration in which the coil 1 is held within the casing 5, and the shaft 2 is arranged along the central axis of the coil 1, and is borne through the bearing 6 provided at the central portion of the base 9. The plunger 3 formed in the shape of a flange is mounted around the outer circumference of the shaft 2. In FIG. 13, when the shaft 2 is moved in the attraction direction, the back face (lower face in the drawing) of the plunger 3 is moved up to the air-gap spacer 7 formed of a metal foil provided to the face on the base 9 opposite to the end portion of the plunger 3. In FIG. 14, the back face (lower face in the drawing) of the plunger 3 is moved up to the air-gap spacer 7 provided to the edge face (upper face in the drawing) on the casing 5 (see Patent document 1).

Using the attracting force which acts between the plunger (movable portion) 3 and the base (fixed portion) 9, and which is generated by applying an electric current to the coil 1, the solenoid performs the driving operation by rapidly and linearly moving the plunger (movable portion) 3 toward the base (fixed portion) 9 along the axis direction thereof until the plunger 3 comes in contact with the base (fixed portion) 9, thereby providing a mechanical motion to an external mechanism. During the electric current is continuously applied to the coil 1, such an arrangement maintains the plunger (movable portion) 3 in contact with the base (fixed portion) 9. When the supply of the electric current to the coil is stopped, the plunger 3 is returned to the original position by the external mechanism connected to the shaft (movable portion) 2 or the force of an unshown restoring spring.

As shown in FIG. 12, the relation between the distance (stroke (mm) represented by the horizontal axis in the drawing) between the fixed magnetic pole portion configured of the base (fixed portion) 9 and the movable magnetic pole portion configured of the plunger (movable portion) 3 and the generated force (force (N) represented by the vertical axis in the drawing) is as follows. That is to say, such an arrangement has the properties that the force rapidly increases corresponding to reduction in the distance (stroke), and when the distance (stroke) becomes zero, the force reaches the maximum value.

In some cases, such properties can lead to adverse effects on the driving of the mechanical load. In particular, in a case in which there is a need to drive a mechanical load with a considerably long path length, such an arrangement requires a large-size solenoid to drive such a mechanical load. In order to solve such a problem, an arrangement has been made in which the force characteristics of the solenoid are adjusted by adjusting the shape of the fixed magnetic pole portion configured of the base (fixed portion) 9 and the shape of the opposing face of the movable magnetic pole portion configured of the plunger (movable portion) 3.

The flat-type solenoid (indicated by F-type in FIG. 12) shown in FIG. 13, which is generally known, provides large force in a range where the distance (stroke) is small, as shown in FIG. 12. Accordingly, the flat-type solenoid is effective in usage with a short driving path. On the other hand, the cone-type solenoid (indicated by C-type in FIG. 12) shown in FIG. 14 cannot provide large force in a range where the distance (stroke) is small, unlike the force characteristics of the flat-type solenoid, as shown in FIG. 12. However, the cone-type solenoid provides approximately flat-curve force characteristics, regardless of the distance (stroke). Accordingly, the cone-type solenoid is effective in usage with a long driving path.

It should be noted that the force characteristics of the cone-type solenoid can be adjusted so as to be close to the flat-curve force characteristic by reducing the angle of the end portion. Accordingly, the optimum value can be selected by adjusting the angle of the end portion according to the size of the mechanical load and the tendency of application of the mechanical load.

Patent document 1: Japanese Unexamined Patent Application Publication No. 2003-338408

### DISCLOSURE OF INVENTION

### Problems to be Solved by the Invention

As shown in FIG. 12, with regard to the cone-type solenoid shown in FIG. 14, in a case in which the solenoid is to be driven with a long operation distance, the angle of the end portion should be reduced. However, the region that provides effective force starts from near the position at which the end of the movable magnetic pole portion configured of the plunger (movable portion) 3 reaches the edge of the fixed magnetic pole cone configured of the base (fixed portion) 9. Accordingly, such an arrangement requires the solenoid with an overall length twice or more the length of the end portion having the end angle. Accordingly, in a case in which the solenoid should be driven with a long operation distance, there is a problem in that the overall length of the solenoid is unavoidably increased according to the necessary operation distance.

In particular, required structures of solenoids vary according to various conditions at devices in which the solenoids are installed. Especially, in recent years, there is an increased demand for reducing the size of solenoids due to reduction in device size. Accordingly, there is an increased demand for reducing the outer size of the solenoids as much as possible while maintaining the same performance.

As described above, the properties of the solenoid can be adjusted so as to match the properties of the load by adjusting the end angle. However, the reduction in the end angle leads to an increase in the overall length of the solenoid. Accordingly, there is a need to employ a method for solving this problem, examples of which include a method for amplifying or changing the motion by means of a link mechanism, and a method employing another driving source, leading to other problems.

The present invention has been made in view of the above-described problems. Accordingly, it is an object of the present invention to provide a solenoid with a reduced overall length which provides the same force performance as conventional solenoids or higher.

### Means for Solving the Problems

In order to solve the aforementioned problems, the present invention proposes the following items.

(1) The present invention proposes a solenoid including: a fixed portion (which corresponds to a base 9 shown in FIG. 14, for example); and a movable portion (which corresponds to a plunger 3 shown in FIG. 14, for example). With such an arrangement, the end of the movable portion includes a magnetic pole portion having at least two tapered faces. Furthermore, the end of the fixed portion includes a magnetic pole portion having at least two tapered faces opposing the magnetic pole portion of the movable portion.

The present invention provides a configuration in which the end of the movable portion includes a magnetic pole portion formed with at least two tapered faces, and the end of the fixed portion includes a magnetic pole portion formed with at least two tapered faces opposing the magnetic pole portion of the movable portion.

Thus, the above-described configuration including the movable portion and the fixed portion maintains the force characteristics of the cone-type solenoid in a range where the distance (stroke) is large, and the force characteristics of the flat-type solenoid in a range where the distance (stroke) is small.

(2) Also, the present invention proposes a solenoid described in (1), in which the magnetic pole portion of the movable portion and the magnetic pole portion of the fixed portion have multiple tapered faces opposing one another.

The present invention provides a structure in which the magnetic pole portion of the movable portion and the magnetic pole portion of the fixed portion have multiple tapered faces opposing one another. Thus, the above-described structure allows the force characteristics to be adjusted over a wide range.

### ADVANTAGES

The present invention provides the advantage of reducing the overall length of the solenoid, as well as providing the same force performance as conventional solenoids or higher.

### BRIEF DESCRIPTION OF THE DRAWINGS

FIG. 1 is a cross-sectional diagram which shows an end portion of a plunger according to a first embodiment of the present invention.

FIG. 2 is a cross-sectional diagram which shows an end portion of a plunger according to a second embodiment of the present invention.

FIG. 3 is a cross-sectional diagram which shows an end portion of a plunger according to a third embodiment of the present invention.

FIG. 4 is a diagram which shows the relation between a first conical angle and a second conical angle.

FIG. 5 is a diagram which shows a comparison between the end length of a conventional cone-type solenoid and the end length of a solenoid according to the present invention.

FIG. 6 is a diagram which shows the relation between the force characteristics provided by the first conical angle, the force characteristics provided by the second conical angle, and the force characteristics of the solenoid according to the present invention.

FIG. 7 is a diagram which shows the force characteristics of each solenoid with the operation cycle of 10%.

FIG. 8 is a diagram which shows the force characteristics of each solenoid with the operation cycle of 25%.

FIG. 9 is a diagram which shows the force characteristics of each solenoid with the operation cycle of 50%.

FIG. 10 is a diagram which shows the force characteristics of each solenoid with the operation cycle of 100%.

FIG. 11 is a diagram which shows the operation distance, the end length, and the minimum necessary length of the solenoid.

FIG. 12 is a diagram which shows the relation between the size of the end angle and the force.

FIG. 13 is a cross-sectional diagram which shows a conventional flat-type solenoid.

FIG. 14 is a cross-sectional diagram which shows a conventional cone-type solenoid.

### REFERENCE NUMERALS

1 coil
2 shaft
3 plunger (movable portion)
5 casing
6 bearing
7 air-gap spacer
8 bobbin
9 base (fixed portion)

### BEST MODE FOR CARRYING OUT THE INVENTION

Detailed description will be made below regarding a solenoid according to an embodiment of the present invention with reference to the drawings.

It should be noted that description will be made in the present embodiment regarding a cone-type solenoid as an example.

Also, the components employed in the present embodiment may be replaced by existing components as appropriate. Also, various modifications may be made by making various combinations with other existing components. Accordingly, description of the present embodiment is by no means intended to limit the content of the present invention described in the appended claims.

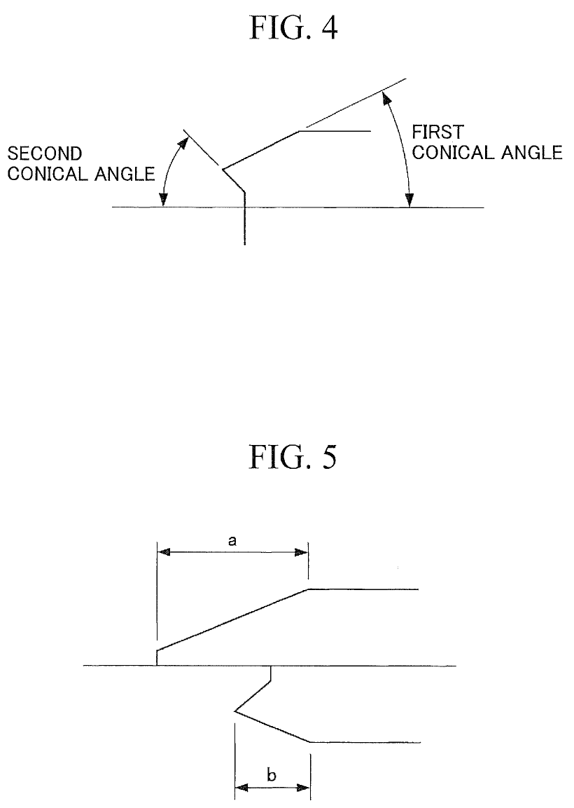

The solenoid according to the present embodiment includes a protrusion at the end portion (tip portion) of the plunger (movable portion) 3 by forming a tapered portion having two conical angles (first conical angle and second conical angle in the drawing) as shown in FIG. 4. The solenoid of this type will be referred to as “double-face-tapered type solenoid” hereafter.

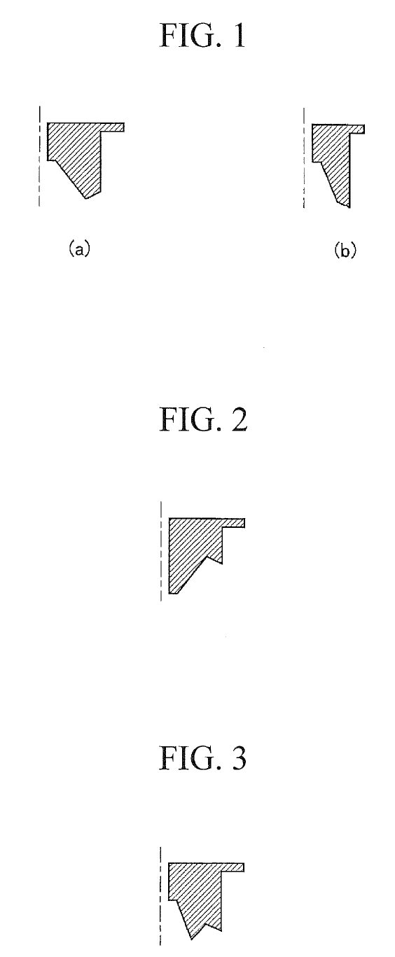

Specifically, the end portion of the plunger (movable portion) 3 is formed in a cross-sectional shape as shown in FIG. 1(a) or FIG. 1(b). Furthermore, the end portion of the base (fixed portion) 9, which is not shown, is formed such that, when the end portion of the base 9 faces the end portion of the plunger (movable portion) 3, the gap formed therebetween is approximately uniform.

More specifically, the end portion that serves as the double-face-tapered type magnetic pole portion is formed in the shape of a ring surrounding the central axis of the magnetic pole portion. The end portion is tapered at a certain angle (first conical angle), with a tapered face extending to the outer circumference. Furthermore, the end portion is tapered at another certain angle, with another tapered face extending to the inner circumference. These two conical angles differ one from another.

FIG. 1 shows an arrangement according to the present embodiment in which the first conical angle and the second conical angle differ from one another. Also, these two angles may be the same. In general, the end portion that serves as a magnetic pole is formed in the shape of a circular ring. Also, the end portion may be formed in the shape of a polygonal ring such as a squire ring, hexagonal ring, or the like. With such an arrangement, the magnetic pole portion is formed in the overall shape of a multi-sided truncated pyramid such as a four-sided truncated pyramid, six-sided truncated pyramid, or the like, with the flat tapered faces.

Also, the end portion may be tapered with a flat tapered face having the first conical angle, and with another flat tapered face having the second conical angle. It should be noted that the end portion cannot physically be formed in a sharp shape. Accordingly, the end portion may be rounded. Also, a flat portion or a recess may be provided to the end portion for the purpose of adjusting the properties of the solenoid.

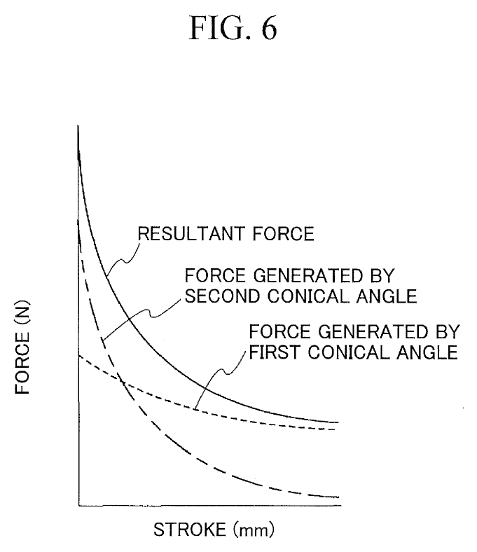

The force characteristics of the solenoid according to the present embodiment approximately match the resultant force characteristics (solid line in the drawing) obtained by adding the force characteristics (dotted line in the drawing) provided by the first conical angle and the force characteristics (broken line in the drawing) provided by the second conical angle, as shown in FIG. 6. The resultant force characteristics have both the flat-type-solenoid characteristics in which the force rapidly increases corresponding to reduction in the distance (stroke), and the cone-type-solenoid characteristics in which, even when the distance (stroke) is large, the force is reduced at a low rate corresponding to an increase in the distance (stroke).

With such an arrangement, the length “b” of the end portion of the plunger (movable portion) 3 is smaller than the end length “a” of the ordinary cone-type solenoid, as shown in FIG. 5. Thus, it can be understood that such an arrangement reduces the overall length of the solenoid, as well as providing the same force performance as conventional ones or higher. It should be noted that the force characteristics of the solenoid according to the present embodiment can be adjusted as appropriate by adjusting the two conical angles as shown in FIG. 1(a) and FIG. 1(b).

Thus, with the present embodiment, a protrusion is provided to the end portion of the plunger (movable portion) 3 by forming a tapered portion having two conical angles. Furthermore, the two conical angles are adjusted, thereby reducing the overall length of the solenoid as compared with conventional solenoids, as well as providing the demanded force characteristics.

### SECOND EMBODIMENT

The solenoid according to the present embodiment includes a single recess at the end portion of the plunger (movable portion) 3 by forming a tapered portion having two conical angles. The solenoid of this type will be referred to as “recessed double-face-tapered type solenoid” hereafter.

Specifically, the end portion of the plunger (movable portion) 3 is formed in a cross-sectional shape as shown in FIG. 2. Furthermore, the end portion of the base (fixed portion) 9, which is not shown, is formed such that, when the end portion of the base 9 faces the end portion of the plunger (movable portion) 3, the gap formed therebetween is approximately uniform.

More specifically, the end portion that serves as the recessed double-face-tapered type magnetic pole portion is formed in the shape of a ring surrounding the central axis of the magnetic pole portion. The end portion is tapered at a certain angle (first conical angle), with a tapered face extending to the outer circumference. Furthermore, the end portion is tapered at another certain angle, with another tapered face extending to the inner circumference. These two conical angles differ one from another.

FIG. 2 shows an arrangement according to the present embodiment in which the first conical angle and the second conical angle differ from one another. Also, these two angles may be the same. In general, the end portion that serves as a magnetic pole is formed in the shape of a circular ring. Also, the end portion may be formed in the shape of a polygonal ring such as a squire ring, hexagonal ring, or the like. With such an arrangement, the magnetic pole portion is formed in the overall shape of a multi-sided truncated pyramid such as a four-sided truncated pyramid, six-sided truncated pyramid, or the like, with the flat tapered faces.

Also, the end portion may be tapered with a flat tapered face having the first conical angle, and with another flat tapered face having the second conical angle. It should be noted that the end portion cannot physically be formed in a sharp shape. Accordingly, the end portion may be rounded. Also, a flat portion or a recess may be provided to the end portion for the purpose of adjusting the properties of the solenoid.

The force characteristics of the solenoid according to the present embodiment approximately match the resultant force characteristics obtained by adding the force characteristics provided by the first conical angle and the force characteristics provided by the second conical angle, in the same way as in the first embodiment. The resultant force characteristics have both the flat-type-solenoid characteristics in which the force rapidly increases corresponding to reduction in the distance (stroke), and the cone-type-solenoid characteristics in which, even when the distance (stroke) is large, the force is reduced at a low rate corresponding to an increase in the distance (stroke).

With such an arrangement, the length of the end portion of the plunger (movable portion) 3 is smaller than the end length of the ordinary cone-type solenoid. Thus, such an arrangement reduces the overall length of the solenoid, as well as providing the same force performance as conventional ones or higher. It should be noted that the force characteristics of the solenoid according to the present embodiment can be adjusted as appropriate by adjusting the two conical angles in the same way as in the first embodiment.

Thus, with the present embodiment, a protrusion is provided to the end portion of the plunger (movable portion) 3 by forming a tapered portion having two conical angles. Furthermore, the two conical angles are adjusted, thereby reducing the overall length of the solenoid as compared with conventional solenoids, as well as providing the demanded force characteristics.

### THIRD EMBODIMENT

The solenoid according to the present embodiment includes a protrusion and a recess at the end portion of the plunger (movable portion) 3 by forming a tapered portion having multiple conical angles. The solenoid of this type will be referred to as “triple-face-tapered type solenoid” hereafter.

Specifically, the end portion of the plunger (movable portion) 3 is formed in a cross-sectional shape as shown in FIG. 3. Furthermore, the end portion of the base (fixed portion) 9, which is not shown, is formed such that, when the end portion of the base 9 faces the end portion of the plunger (movable portion) 3, the gap formed therebetween is approximately uniform.

More specifically, the end portion that serves as the triple-face-tapered type magnetic pole portion is formed in the shape of a ring surrounding the central axis of the magnetic pole portion. The end portion is tapered at a certain angle (first conical angle), with a tapered face extending to the outer circumference. Furthermore, the end portion is tapered at another certain angle, with another tapered face extending to the inner circumference (second conical angle). Moreover, the end portion is tapered with yet another tapered face (third conical angle).

FIG. 3 shows an arrangement according to the present embodiment in which the first conical angle through the third conical angle, which provide the protrusion and recess, differ from one another. Also, these angles may be the same. In general, the end portion that serves as a magnetic pole is formed in the shape of a circular ring. Also, the end portion may be formed in the shape of a polygonal ring such as a squire ring, hexagonal ring, or the like. With such an arrangement, the magnetic pole portion is formed in the overall shape of a multi-sided truncated pyramid such as a four-sided truncated pyramid, six-sided truncated pyramid, or the like, with the flat tapered faces.

Also, the end portion may be tapered with a flat tapered face having the first conical angle, with another flat tapered face having the second conical angle, and with yet another flat tapered face having the third conical angle. It should be noted that the end portion cannot physically be formed in a sharp shape. Accordingly, the end portion may be rounded. Also, a flat portion or a recess may be provided to the end portion for the purpose of adjusting the properties of the solenoid.

The force characteristics of the solenoid according to the present embodiment approximately match the resultant force characteristics obtained by adding the force characteristics provided by the multiple conical angles, in the same way as in the first embodiment. The resultant force characteristics have both the flat-type-solenoid characteristics in which the force rapidly increases corresponding to reduction in the distance (stroke), and the cone-type-solenoid characteristics in which, even when the distance (stroke) is large, the force is reduced at a low rate corresponding to an increase in the distance (stroke).

As described above, a solenoid having an increased driving path can be designed by reducing the end angle (tip angle). Such an arrangement provides increased force performance when the magnetic distance is large. However, such an arrangement has a problem of poor force performance when the magnetic distance is small. With the present embodiment, a combination of a large end angle and a small end angle is employed, thereby allowing the force performance in a range where the distance is large and the force performance in a range where the distance is small to be separately controlled. Thus, such an arrangement reduces the overall length of the solenoid, as well as providing the same force performance as conventional solenoids or higher.

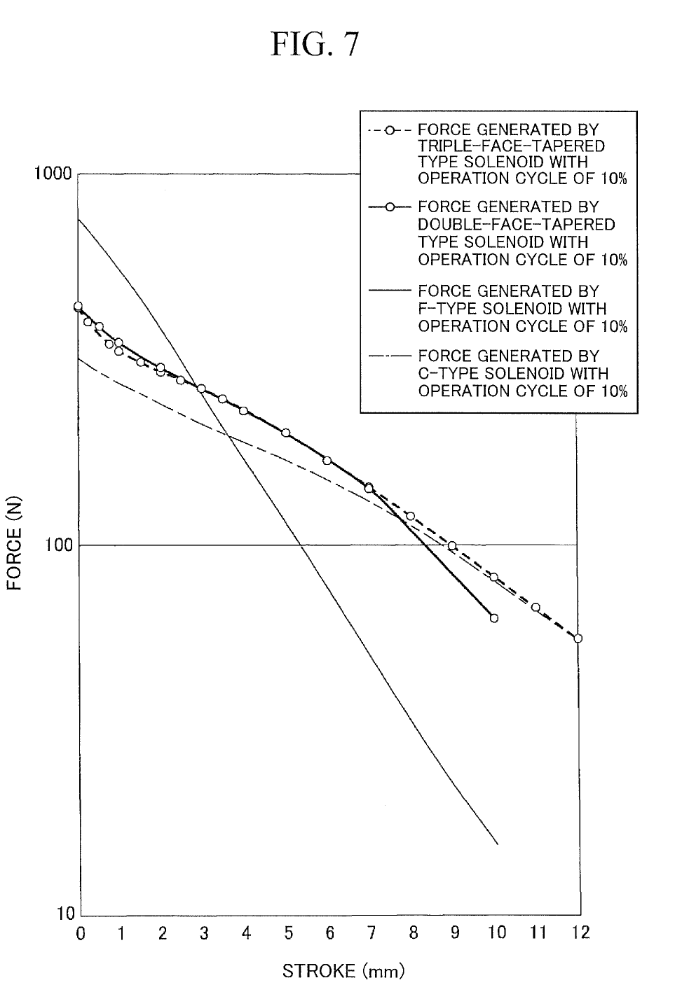

FIG. 7 through FIG. 10 are diagrams each of which shows the force characteristics provided by the flat-type solenoid (F-type, in the drawing), the force characteristics provided by the cone-type solenoid (C-type, in the drawing), the force characteristics of the double-face-tapered type solenoid according to the first embodiment, and the force characteristics of the triple-face-tapered type solenoid according to the third embodiment. Also, FIG. 7 through FIG. 10 shows these force characteristics with operation cycles of 10%, 25%, 50%, and 100%, respectively. Here, the operation cycle, which is set to 10%, 25%, 50%, or 100%, represents the duty ratio of the electric power supplied to the main magnetic circuit of the solenoid. It should be noted that the operation cycle of 100% represents the electric power which can be continuously supplied to the coil without damaging the coil. The duty ratio is defined by the expression, ON period/(ON period+OFF period). Here, the ON period represents the period in time during which the electric power is supplied. The OFF period represents the period in time during which supply of electric power is cut off.

As shown in FIG. 7, when the operation cycle is 10%, both the double-face-tapered type solenoid and the triple-face-tapered type solenoid have the advantages of the conventional flat-type solenoid (F-type in the drawing) and cone-type solenoid (C-type in the drawing). In particular, the triple-face-tapered type solenoid has the further improved force characteristics in a range where the stroke is long.

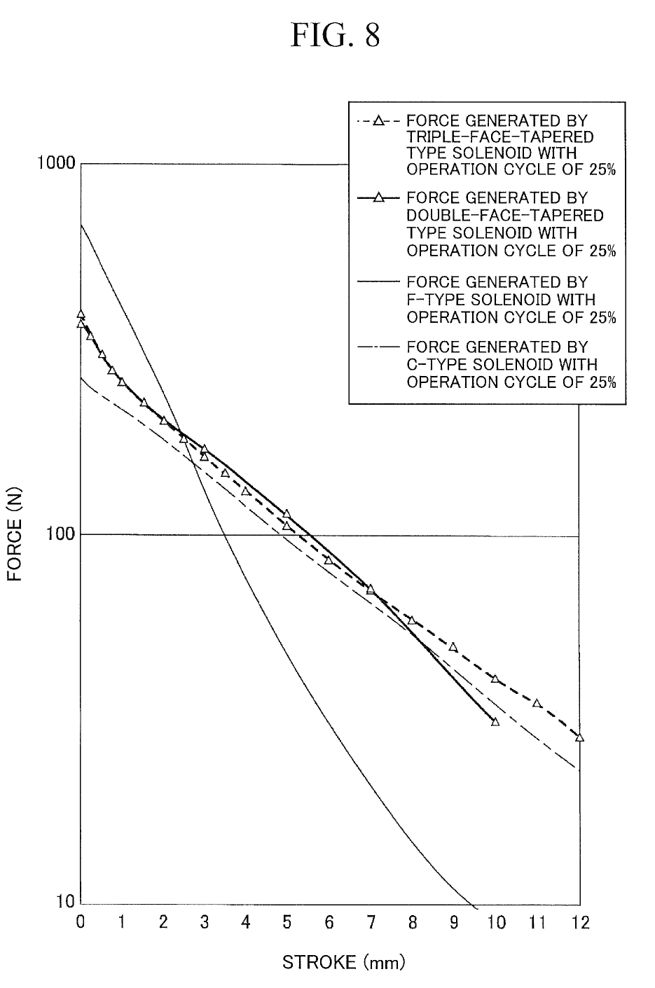

Also, as shown in FIG. 8, when the operation cycle is 25%, both the double-face-tapered type solenoid and the triple-face-tapered type solenoid have the advantages of the conventional flat-type solenoid (F-type in the drawing) and cone-type solenoid (C-type in the drawing). In particular, the triple-face-tapered type solenoid has the further improved force characteristics in a range where the stroke is long.

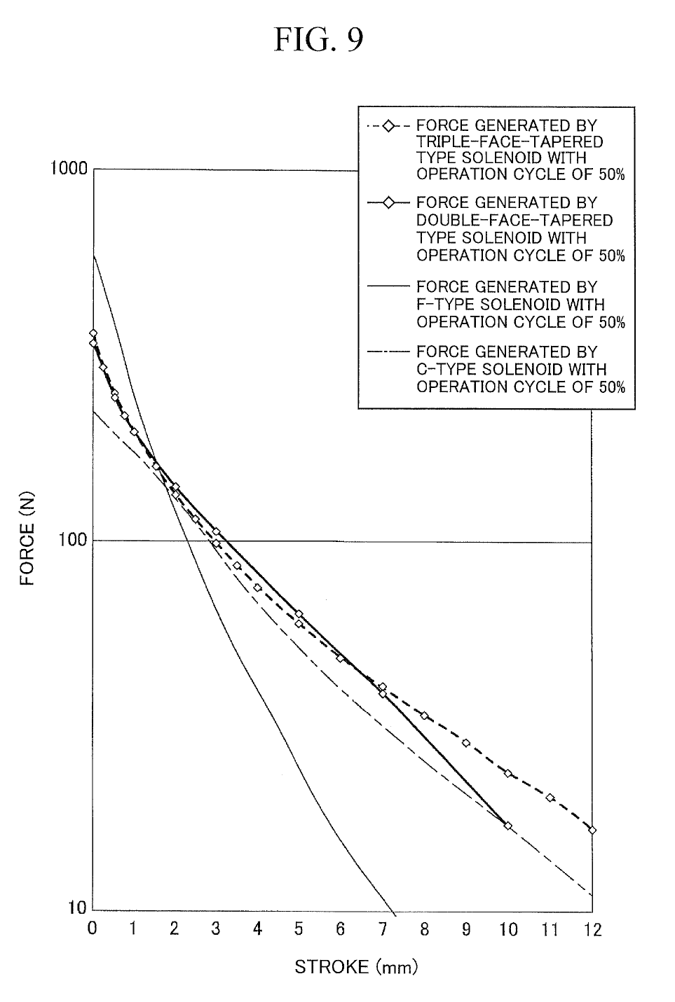

Also, as shown in FIG. 9, when the operation cycle is 50%, both the double-face-tapered type solenoid and the triple-face-tapered type solenoid have the advantages of the conventional flat-type solenoid (F-type in the drawing) and cone-type solenoid (C-type in the drawing). In particular, the triple-face-tapered type solenoid has the further improved force characteristics in a range where the stroke is long.

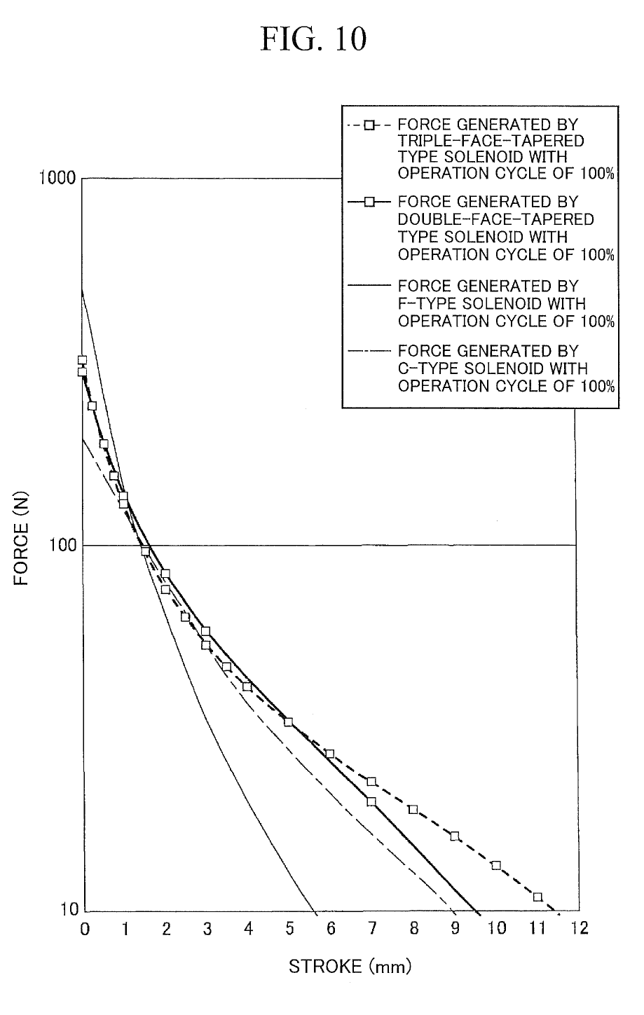

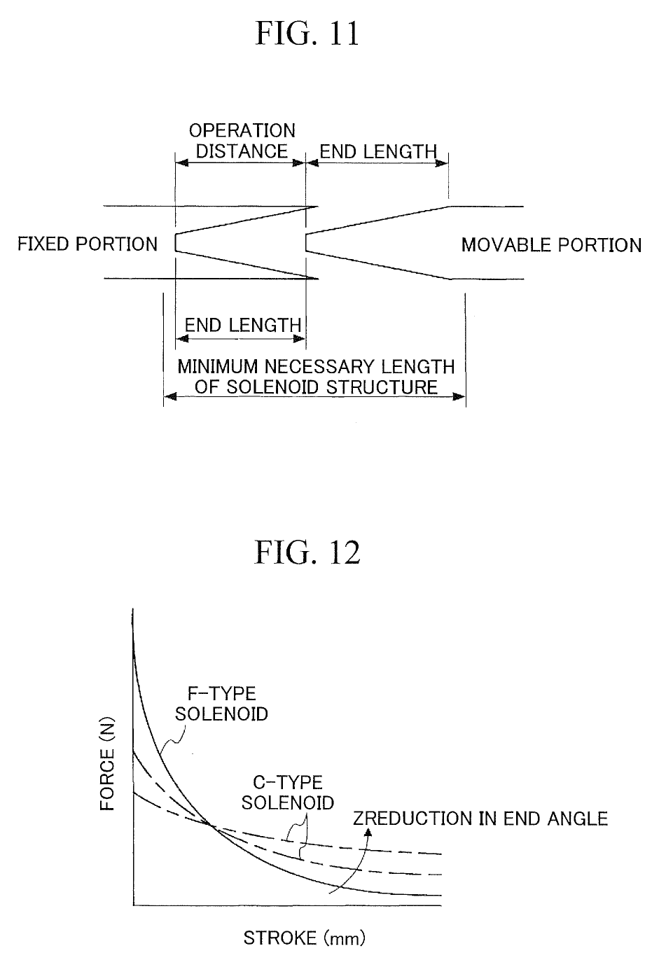

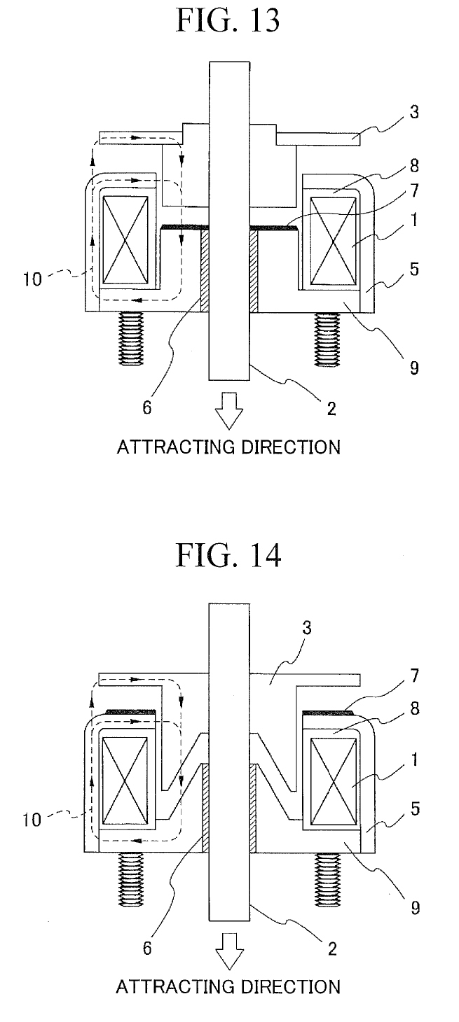

Also, as shown in FIG. 10, when the operation cycle is 100%, both the double-face-tapered type solenoid and the triple-face-tapered type solenoid have the advantages of the conventional flat-type solenoid (F-type in the drawing) and cone-type solenoid (C-type in the drawing). In particular, the triple-face-tapered type solenoid has the further improved force characteristics in a range where the stroke is long.

As described above, the present invention provides a solenoid having force characteristics having the advantages of the conventional flat-type solenoid and cone-type solenoid at each operation cycle by adjusting the conical angles as appropriate. Furthermore, as described in the aforementioned embodiments, the solenoid has a double-face-tapered type structure or a triple-face-tapered type structure. With regard to prototype examples, a prototype solenoid with L of 30.5 mm or less provided 76% reduction in the overall length. A prototype solenoid with L of 22 mm or less provided 62% reduction in the overall length. A prototype solenoid with L of 13 mm or less provided 50% reduction in the overall length. Thus, the present invention provides a solenoid having the demanded force characteristics with a reduced overall length.

Detailed description has been made regarding the embodiments of the present invention with reference to the drawings. Specific configurations are not restricted to the above-described embodiments, and various modifications may be designed without departing from the scope of the present invention, which are also encompassed in the present invention. For example, description has been made regarding a double-face-tapered type solenoid and a triple-face-tapered type solenoid as examples. However, the present invention is not restricted to such examples. It is needless to say that the present invention may also be applied to a so-called multi-face-tapered type solenoid having three or more tapered faces.

1. A solenoid including:
a fixed portion; and
a movable portion,
wherein the end of the movable portion includes a magnetic pole portion having at least two tapered faces,
and wherein the end of the fixed portion includes a magnetic pole portion having at least two tapered faces opposing the magnetic pole portion of the movable portion.

2. A solenoid according to claim 1, wherein the magnetic pole portion of the movable portion and the magnetic pole portion of the fixed portion have a plurality of tapered faces opposing one another.
